(19) United States
(12) Patent Application Publication
(10) Pub. No.: US 2026/0055838 A1
(43) Pub. Date: Feb. 26, 2026

(54) FLUID CONNECTION ASSEMBLY

(71) Applicant: Oetiker NY, Inc., Lancaster, NY (US)

(72) Inventors: Brett Richard White, Colden, NY (US); James Anthony Kujawski, Jr., Attica, NY (US)

(21) Appl. No.: 19/280,417

(22) Filed: Jul. 25, 2025

Related U.S. Application Data
(60) Provisional application No. 63/710,662, filed on Oct. 23, 2024.
(60) Provisional application No. 63/686,195, filed on Aug. 23, 2024.

(51) Int. Cl. F16L 37/23; F16L 37/30

(52) U.S. Cl. CPC F16L 37/23; F16L 37/30

(57) ABSTRACT

A fluid connection assembly, including a plug assembly, including a first end, a second end, a first radially outward facing surface including a first groove, and a first through-bore forming a first radially inward facing surface, a socket assembly, including a third end, a fourth end, a second radially outward facing surface, a second through-bore forming a second radially inward facing surface, one or more holes extending from the second radially outward facing surface to the second radially inward facing surface, a detent arranged in each hole of the one or more holes, and a biasing ring operatively arranged to engage the detents.

### CROSS-SECTION TO RELATED APPLICATIONS

This application claims the benefit under 35 U.S.C. § 119(e) of U.S. Provisional Application No. 63/710,662, filed October 23, 2024, and U.S. Provisional Application No. 63/686,195, filed August 23, 2024, which applications are incorporated herein by reference in their entireties.

### FIELD

The present disclosure relates to fluid connectors, and more particularly, to a fluid connection assembly including a retainer that includes a plug connector assembly and a socket connector assembly that can be pushed together and locked without the need to displace a locking sleeve.

### BACKGROUND

Fluid connectors, fluid connections, or fluid connection assemblies are integral components for many applications, and especially for refrigerant or cooling systems. Since a cooling system is made up of various components, for example refrigeration lines, compressors, and heat pumps, fluid must be able to travel not only within each component but also between components. Refrigeration lines may carry a refrigerant, which is a substance or mixture, usually a fluid, used in a heat pump and refrigeration cycle, and can be hazardous. As such, it is essential that fluid connectors for refrigeration lines be properly secured so as not to allow the release of any refrigerant.

### SUMMARY

The present disclosure is directed to one or more exemplary embodiments of a fluid connection assembly.

In an exemplary embodiment, the fluid connection assembly comprises a plug assembly, including a first end, a second end, a first radially outward facing surface including a first groove, a first through-bore forming a first radially inward facing surface, a first plunger arranged in the first through-bore, and a first spring operatively arranged to bias the first plunger into sealing engagement with the first end, and a socket assembly, including a third end, a fourth end, a second radially outward facing surface, a second through-bore forming a second radially inward facing surface, one or more holes extending from the second radially outward facing surface to the second radially inward facing surface, a detent arranged in each hole of the one or more holes, a biasing ring arranged radially outward of the second radially outward facing surface, the biasing ring operatively arranged to engage the detent, a second plunger arranged in the second through-bore, and a second spring operatively arranged to bias the second plunger into a sealed state.

In an exemplary embodiment, the biasing ring is a non-continuous radially expandable ring operatively arranged to bias the detent radially inward. In an exemplary embodiment, the socket assembly further comprises a sleeve translatably arranged on the second radially outward facing surface. In an exemplary embodiment, the detent is radially and axially displaceable within the one or more holes, and the sleeve and the biasing ring are operatively arranged to engage the detent to displace it radially inward from the second radially inward facing surface. In an exemplary embodiment, the sleeve comprises a third radially inward facing surface, and a second groove arranged on the third radially inward facing surface, wherein the biasing ring is arranged in the second groove and the second groove is operatively arranged to be axially aligned with the one or more holes. In an exemplary embodiment, each hole of the one or more holes comprises a first axial length, the second groove comprises a second axial length, and the second axial length is less than the first axial length. In an exemplary embodiment, the detent is operatively arranged to be displaced radially outward into the second groove by the plug assembly.

In an exemplary embodiment, the fluid connection assembly further comprises a third spring operatively arranged to bias the biasing ring into axial alignment with the one or more holes. In an exemplary embodiment, the socket assembly further comprises a shaft arranged in the second through-bore, and the second spring is operatively arranged to bias the second plunger into sealing engagement with the shaft. In an exemplary embodiment, the second plunger comprises a third radially outward facing surface including a second groove, a first seal arranged in the second groove to provide a fluid tight seal between the second plunger and the second radially inward facing surface, a third radially inward facing surface including a third groove, and a second seal arranged in the third groove to provide a fluid tight seal between the second plunger and the shaft.

In an exemplary embodiment, in an unconnected state the first plunger is sealingly engaged with the first end, and the second plunger is in the sealed state and sealingly engaged with the second radially inward facing surface. In an exemplary embodiment, in a connected state the first end displaces the second plunger in a first axial direction such that the second plunger is in an unsealed state, and the first plunger is displaced in a second axial direction, opposite the first axial direction, such that the first plunger is not sealingly engaged with the first end. In an exemplary embodiment, in the connected state the second plunger is sealingly engaged with the second radially inward facing surface. In an exemplary embodiment, the detent is operatively arranged to engage the first groove and the one or more holes to lock the plug assembly to the socket assembly.

The present disclosure is directed to one or more exemplary embodiments of a fluid connection assembly.

In an exemplary embodiment, the fluid connection assembly comprises a plug assembly, including a first end, a second end, a first radially outward facing surface including a first groove, and a first through-bore forming a first radially inward facing surface, a socket assembly, including a third end, a fourth end, a second radially outward facing surface, a second through-bore forming a second radially inward facing surface, one or more holes extending from the second radially outward facing surface to the second radially inward facing surface, a detent arranged in each hole of the one or more holes, and a biasing ring operatively arranged to engage the detents.

In an exemplary embodiment, the biasing ring is a radially expandable ring operatively arranged to bias the detent radially inward. In an exemplary embodiment, the socket assembly further comprises a sleeve arranged on the second radially outward facing surface, the sleeve comprises a third radially inward facing surface including a second groove, and the biasing ring is arranged in the second groove and operatively arranged to be axially aligned with the one or more holes. In an exemplary embodiment, each hole of the one or more holes comprises a first axial length, the second groove comprises a second axial length, and the second axial length is less than the first axial length. In an exemplary embodiment, the detent is operatively arranged to be displaced radially outward into the second groove by the plug assembly, and engage the first groove and the one or more holes to lock the plug assembly to the socket assembly. In an exemplary embodiment, the detent is radially and axially displaceable within the one or more holes, and the biasing ring is translatably arranged on the second radially outward facing surface.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front perspective view of a fluid connection assembly.

FIG. 1B is a rear perspective view of the fluid connection assembly shown in FIG. 1A.

FIG. 2 is a front partial exploded perspective view of the fluid connection assembly shown in FIG. 1A.

FIG. 3A is a rear perspective view of the plug assembly shown in FIG. 1A.

FIG. 3B is a front elevational view of the plug assembly shown in FIG. 1A.

FIG. 4 is a cross-sectional view of the plug assembly taken generally along line 4-4 in FIG. 3A.

FIG. 5 is an exploded front perspective view of the plug assembly shown in FIG. 1A.

FIG. 6A is a front perspective view of the socket assembly shown in FIG. 1A.

FIG. 6B is a top plan view of the socket assembly shown in FIG. 1A, with the sleeve and biasing ring removed.

FIG. 7 is a cross-sectional view of the socket assembly taken generally along line 7-7 in FIG. 6A.

FIG. 8 is an exploded front perspective view of the socket assembly shown in FIG. 1A.

FIG. 9 is a cross-sectional view of the fluid connection assembly taken generally along line 9-9 in FIG. 1A.

FIG. 10A is a cross-sectional view of the fluid connection assembly taken generally along line 9-9 in FIG. 1A, in an unlocked state.

FIG. 10B is a cross-sectional view of the fluid connection assembly taken generally along line 9-9 in FIG. 1A, in a partially engaged state.

FIG. 10C is a cross-sectional view of the fluid connection assembly taken generally along line 9-9 in FIG. 1A, in a locked state.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

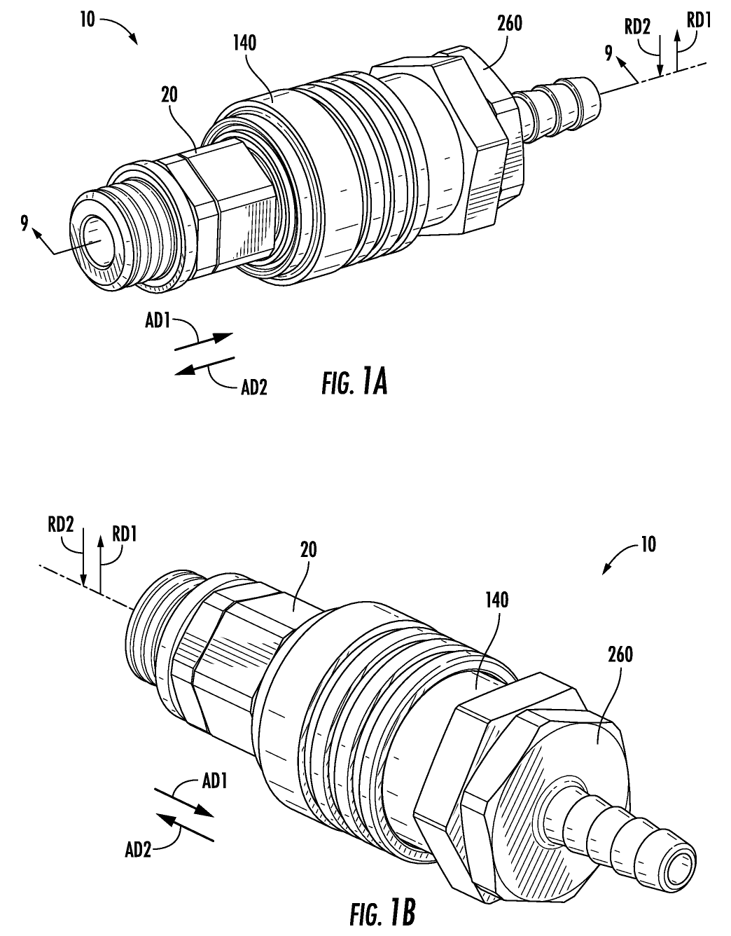

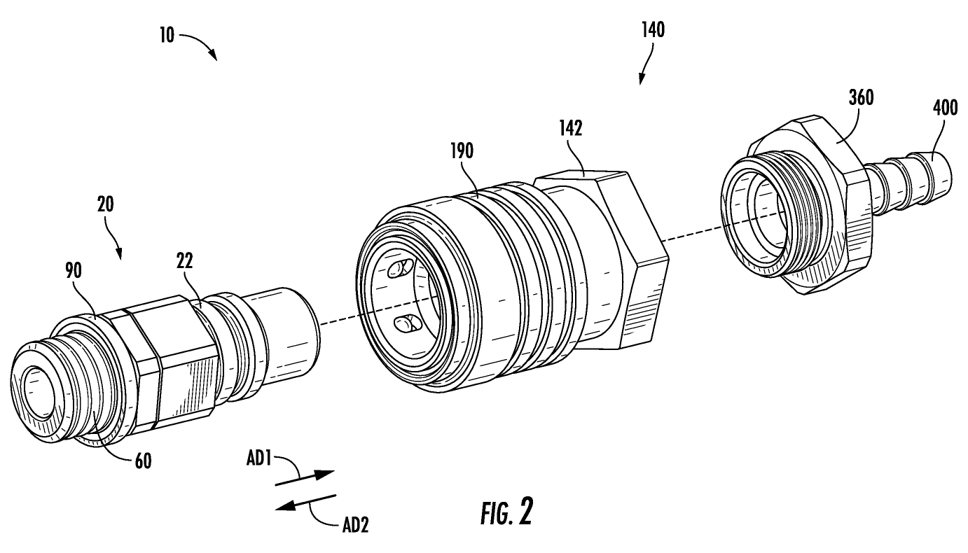

Adverting now to the figures, FIG. 1A is a front perspective view of fluid connection assembly 10. FIG. 1B is a rear perspective view of fluid connection assembly 10. FIG. 2 is a front partial exploded perspective view of fluid connection assembly 10. Fluid connection assembly 10 generally comprises plug assembly 20 and socket assembly 140. In an exemplary embodiment, fluid connection assembly 10 comprises a tube connected or arranged to be connected to at least one of plug assembly 20 and socket assembly 140.

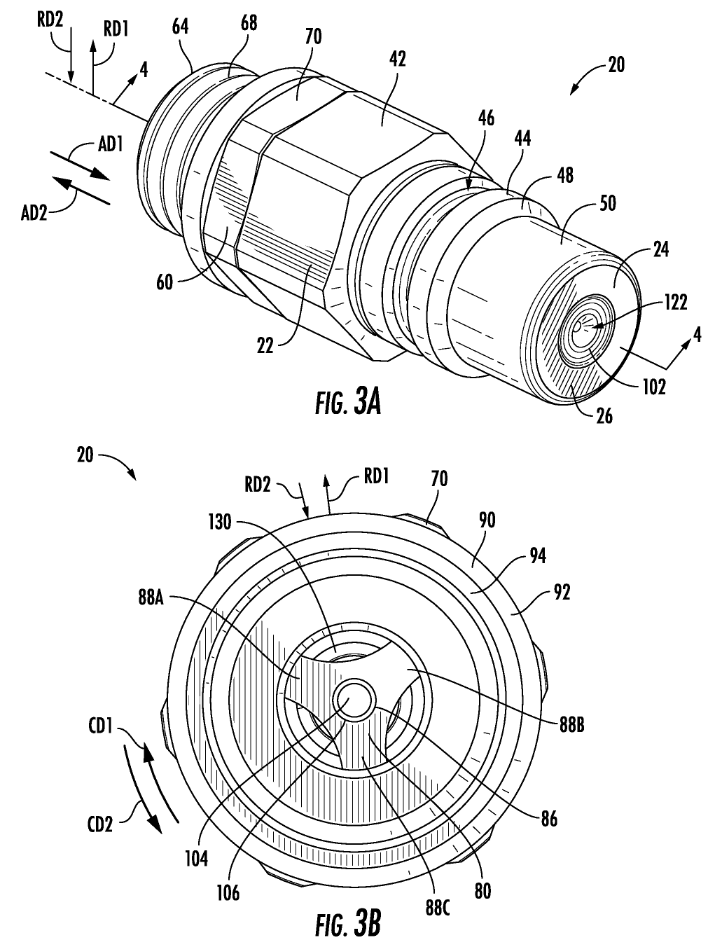

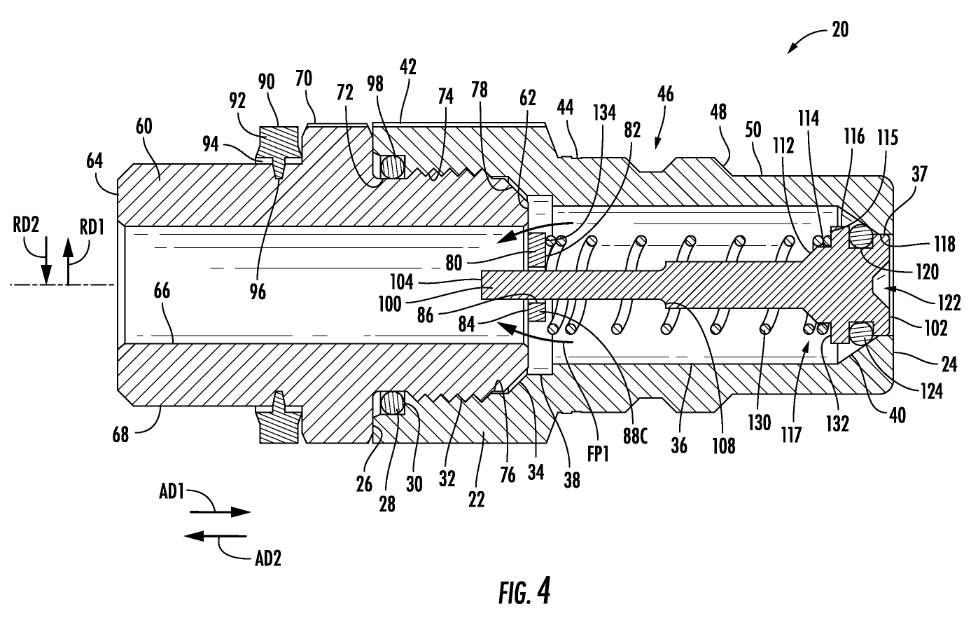

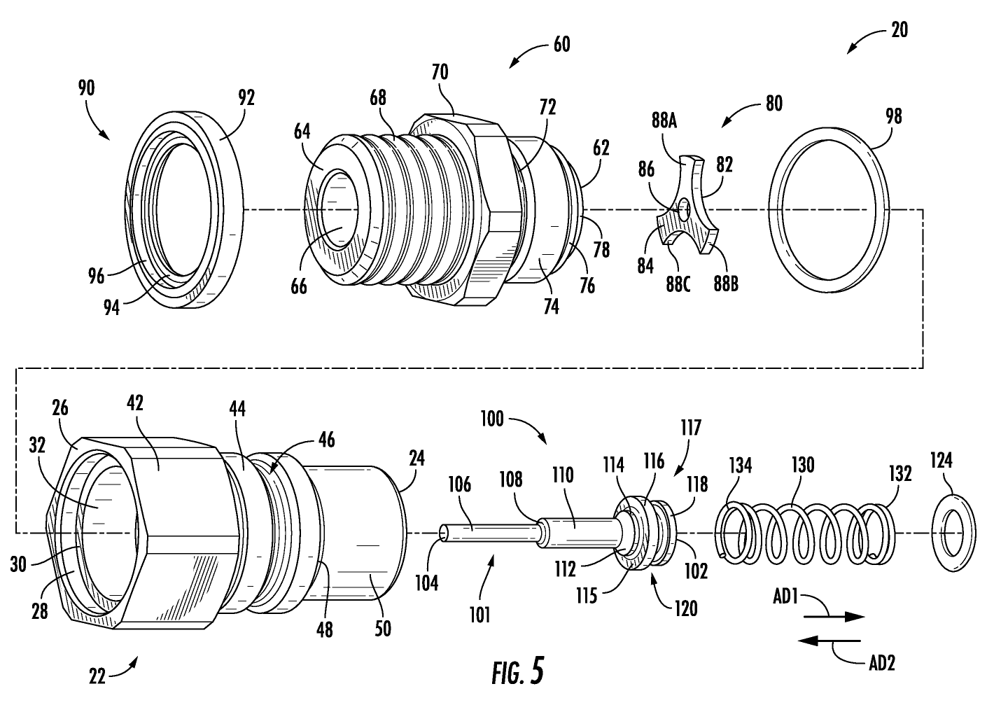

FIG. 3A is a rear perspective view of plug assembly 20. FIG. 3B is a front elevational view of plug assembly 20. FIG. 4 is a cross-sectional view of plug assembly 20 taken generally along line 4-4 in FIG. 3A. FIG. 5 is an exploded front perspective view of plug assembly 20. Plug assembly 20 generally comprises connector body 22, plunger 100, and biasing element or spring 130. In an exemplary embodiment, plug assembly 20 further comprises securing body 60.

Connector body 22 comprises end 24, end 26, at least one radially inward facing surface, for example, radially inward facing surface 28, radially inward facing surface 32, radially inward facing surface 36, and radially inward facing surface 37, and at least one radially outward facing surface, for example, radially outward facing surface 44 and radially outward facing surface 50. Radially inward facing surface 28 extends from end 26 in axial direction AD1 and is connected to radially inward facing surface 32 via axial surface 30. Axial surface 30 extends radially inward from radially inward facing surface 28, and generally faces in axial direction AD2. In an exemplary embodiment, seal 98 is arranged in the recess or groove formed by radially inward facing surface 28 and axial surface 30, to provide a fluid tight seal between connector body 22 and securing body 60. Radially inward facing surface 32 extends from axial surface 30 in axial direction AD1. In an exemplary embodiment, radially inward facing surface 32 is at least partially threaded. Radially inward facing surface 32 is connected to radially inward facing surface 36 via surface 34. In an exemplary embodiment, surface 34 is a frusto-conical surface decreasing in diameter in axial direction AD1. Radially inward facing surface 36 extends from surface 34 in axial direction AD1. In an exemplary embodiment, radially inward facing surface 36 comprises recess or groove 38. Radially inward facing surface 37 extends from end 24 in axial direction AD2 and is connected to radially inward facing surface 36 via surface 40. In an exemplary embodiment, surface 40 is a frusto-conical surface decreasing in diameter in axial direction AD1.

Radially outward facing surface 50 extends in axial direction AD2 from end 24 and is operatively arranged to engage socket assembly 140. Radially outward facing surface 50 is connected to radially outward facing surface 44 via surface 48. In an exemplary embodiment, surface 48 is a frusto-conical surface increasing in diameter in axial direction AD2. Radially outward facing surface 44 comprises groove 46 operatively arranged to engage with detents or balls 184 to secure plug assembly 20 to socket assembly 140. In an exemplary embodiment, groove 46 comprises a constant diameter radially outward facing surface, a first frusto-conical surface arranged on a first axial side of the constant diameter radially outward facing surface and increasing in diameter in axial direction AD1, and a second frusto-conical surface arranged on a second axial side of the constant diameter radially outward facing surface and increasing in diameter in axial direction AD2. Connector body 22 further comprises head 42. Connector body 22 may be screwed onto a component, such as securing body 60, via head 42 (e.g., using a wrench). In an exemplary embodiment, head 42 is hexagonal; however, it should be appreciated that head 42 may comprise any geometry suitable for applying torque to connector body 22.

In an exemplary embodiment, plug assembly 20 further comprises stopper 80. Stopper 80 comprises end 82, end 84, through-bore 86, and a plurality of radially outward extending projections circumferentially spaced apart from each other, for example, radially outward extending projections 88A-88C. As best shown in FIG. 4, stopper 80 is arranged in recess or groove 38 such that end 82 abuts against an axial surface of connector body 22. Stopper 80 is secured in recess 38 via securing body 60, namely, end 62. It should be appreciated, however, that in an exemplary embodiment stopper 80 may be secured in connector body 22 via any suitable means, for example, adhesive, welding, soldering or brazing, etc. The circumferential spaces between radially outward extending projections 88A-88C allow the flow of fluid through stopper 80, as indicated by flow path arrows FP1 in FIG. 4. Through-bore 86 is operatively arranged to slidingly engage plunger 100. In an exemplary embodiment, stopper 80 is removably connected to connector body 22.

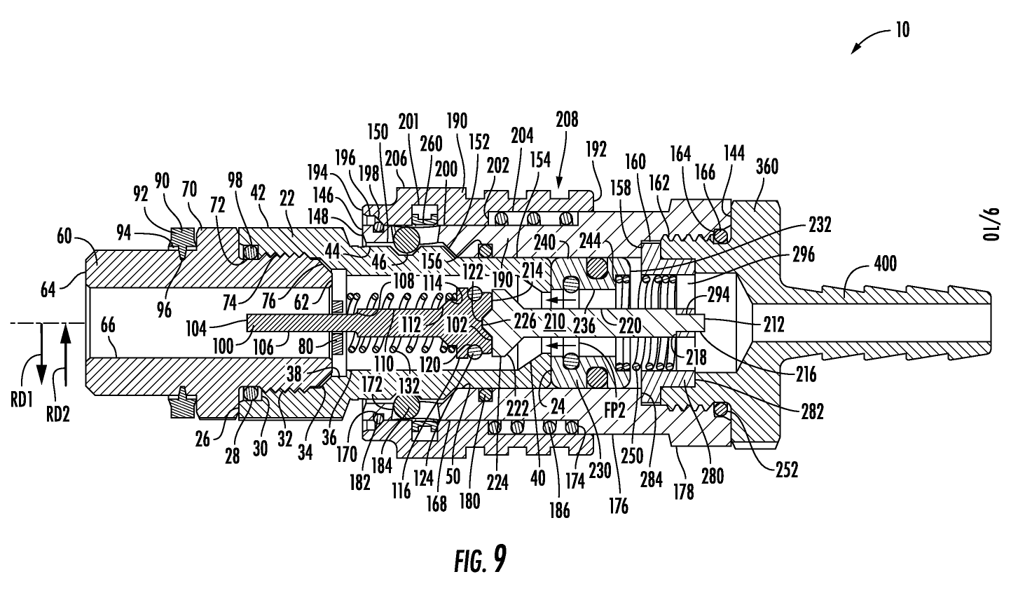

Plunger 100 comprises stem portion 101 and sealing head 117. Specifically, plunger 100 comprises end 102, end 104, and at least one radially outward facing surface, for example, radially outward facing surface 106, radially outward facing surface 110, radially outward facing surface 116, and radially outward facing surface 118. Radially outward facing surface 106 extends from end 104 in axial direction AD1 and is operatively arranged to slidingly engage through-bore 86. Radially outward facing surface 106 is connected to radially outward facing surface 110 via axial surface 108. Axial surface 108 generally faces in axial direction AD2 and is operatively arranged to engage end 82 of stopper 80 to prevent displacement of plunger 100 in axial direction AD2. In an exemplary embodiment, axial surface 108 is a frusto-conical surface increasing in diameter in axial direction AD1. In the closed or unconnected state, as best shown in FIG. 4, surface 108 is spaced apart axially from end 82 by a first distance. In the open state, as best shown in FIG. 9, surface 108 abuts against end 82, or surface 108 is spaced apart axially from end 82 by a second distance, less than the first distance.

Radially outward facing surface 110 is connected to radially outward facing surface 114 via surface 112. In an exemplary embodiment, surface 112 is a frusto-conical surface increasing in diameter in axial direction AD1. Radially outward facing surface 114 is connected to radially outward facing surface 116 via axial surface 115. Radially outward facing surface 118 extends from end 102 in axial direction AD2 and is axially spaced apart from radially outward facing surface 116 via groove 120. Seal 124 is arranged in groove 120. Radially outward facing surfaces 116 and 118, groove 120, and seal 124 form sealing head 117 of plunger 100. In an exemplary embodiment, end 102 further comprises alignment recess 122. Recess 122 is operatively arranged to engage protrusion 226 of shaft 210 such that sealing head 117 does not displace radially with respect to stopper 80.

In an exemplary embodiment, radially outward facing surface 116 comprises a first diameter and radially outward facing surface 118 comprises a second diameter, less than the first diameter. In an exemplary embodiment, the diameter of radially outward facing surface 116 is greater than the diameter of radially inward facing surface 37 to prevent plunger 100 from being removed from connector body 22 in axial direction AD1. This allows plug assembly 20 to be pressurized without the need to be connected to socket assembly 140. For example, when plug assembly 20 is pressurized, the fluid pressure will force plunger 100 in axial direction AD1 and into sealing engagement with connector body 22, namely, surface 40 or end 24.

Spring 130 is operatively arranged to bias plunger 100 in axial direction AD1. Spring 130 comprises end 132 arranged to engage sealing head 117 of plunger 100 (e.g., axial surface 115) and end 134 arranged to engage end 82 of stopper 80. Spring 130 biases plunger 100 to the closed state. In the closed state shown in FIG. 4, radially outward facing surface 118 is engaged with radially inward facing surface 37 and seal 124 is engaged with surface 40 and/or radially inward facing surface 37, thereby preventing the flow of fluid into end 24 in axial direction AD2, or axial direction AD1. In the open state shown in FIG. 9, plunger 100 is displaced in axial direction AD2 with respect to connector body 22, for example by shaft 210, such that radially outward facing surface 118 is axially spaced apart from radially inward facing surface 37. This allows fluid to flow into end 24, as indicated by flow path arrows FP2 in FIG. 9.

Securing body 60 comprises end 62, end 64, radially inward facing surface 66, and at least one radially outward facing surface, for example, radially outward facing surface 68 and radially outward facing surface 72. Radially outward facing surface 68 extends from end 64 in axial direction AD1. In an exemplary embodiment, radially outward facing surface 68 is operatively arranged to be connected to a tube or other component, for example, via brazing, a pipe clamp, or another suitable securing means such as threading. Radially outward facing surface 72 extends from end 62 in axial direction AD2 and is operatively arranged to engage connector body 22. In an exemplary embodiment, radially outward facing surface 72 is connected to end 62 via frusto-conical surface 78. Frusto-conical surface 78 decreases in diameter in axial direction AD1. In an exemplary embodiment, radially outward facing surface 72 is at least partially threaded, comprising threading 74. In an exemplary embodiment, threading 74 is arranged axially between and spaced apart from head 70 and surface 78. In such embodiment, seal 98 is arranged to engage an unthreaded portion of radially outward facing surface 72, as best shown in FIGS. 4 and 9.

In an exemplary embodiment, securing body 60 may further comprise head 70 arranged axially between radially outward facing surface 68 and radially outward facing surface 72. Securing body 60 may be screwed onto a component, such as connector body 22, via head 70 (e.g., using a wrench). In an exemplary embodiment, head 70 is hexagonal; however, it should be appreciated that head 70 may comprise any geometry suitable for applying torque to securing body 60.

In an exemplary embodiment, plug assembly 20 further comprises ring assembly 90. Ring assembly 90 comprises outer ring 92 and seal 94 connected to a radially inward facing surface of outer ring 92. Outer ring 92 and seal 94 are arranged concentrically. Seal 94 is operatively arranged to engage radially outward facing surface 68. In an exemplary embodiment, seal 94 comprises radially inward extending flange 96. Flange 96 is arranged axially between and spaced apart from both axial ends of seal 94. In an exemplary embodiment, ring assembly 90 is a seal washer (i.e., a metal washer with a rubber seal).

To assemble plug assembly 20, seal 124 is arranged in groove 120 of plunger 100, and spring 130 is arranged generally around radially outward facing surface 106 and radially outward facing surface 110. Plunger 100 and spring 130 are arranged in connector body 22 and generally aligned with radially inward facing surface 36. Stopper 80 is arranged in connector body 22 such that through-bore 86 engages plunger 100, namely, radially outward facing surface 106. Stopper 80 is arranged in recess 38. Seal 98 is arranged on radially outward facing surface 72 of securing body 60, preferably in the non-threaded portion next to head 70. Securing body 60 is then connected to connector body 22. For example, securing body 60 is connected to connector body 22 via threading 74 and 32. In the connected state, end 62 of securing body 60 is engaged with end 84 to secure stopper 80 in recess 38, and seal 98 is engaged with radially inward facing surface 28.

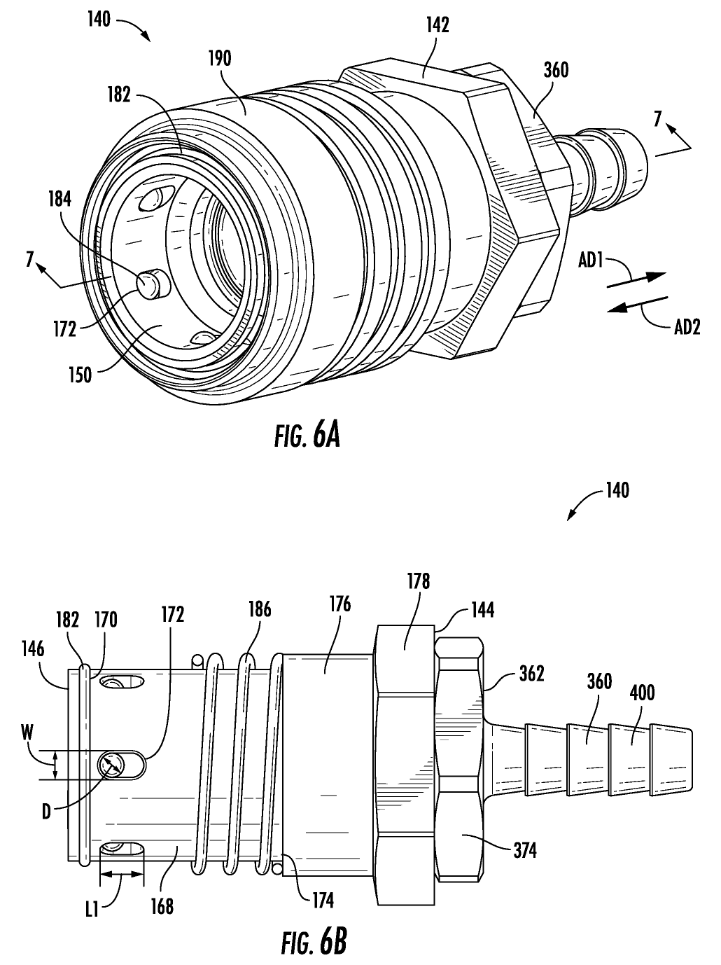

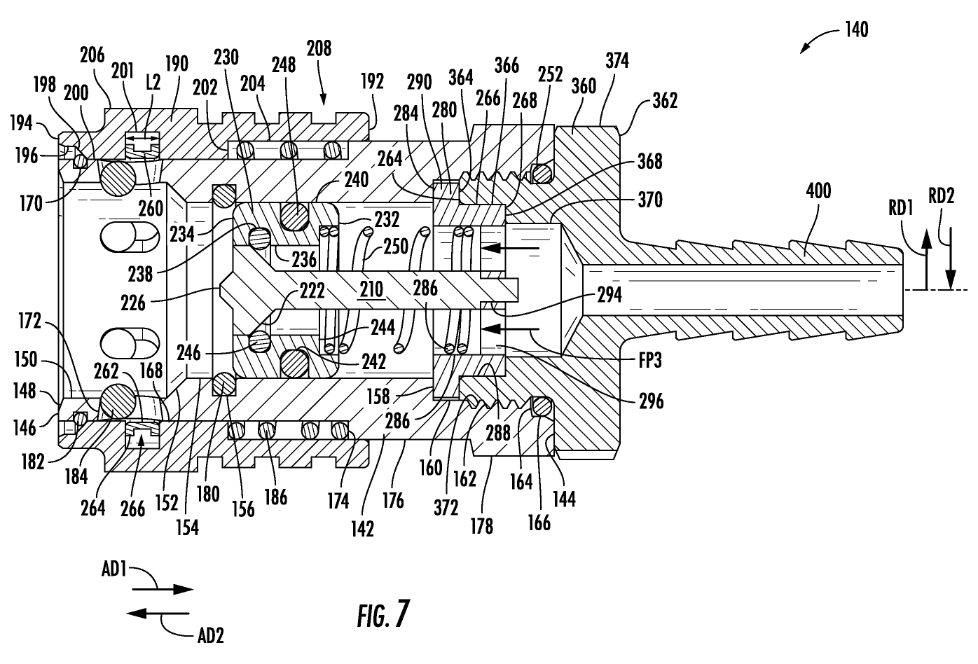

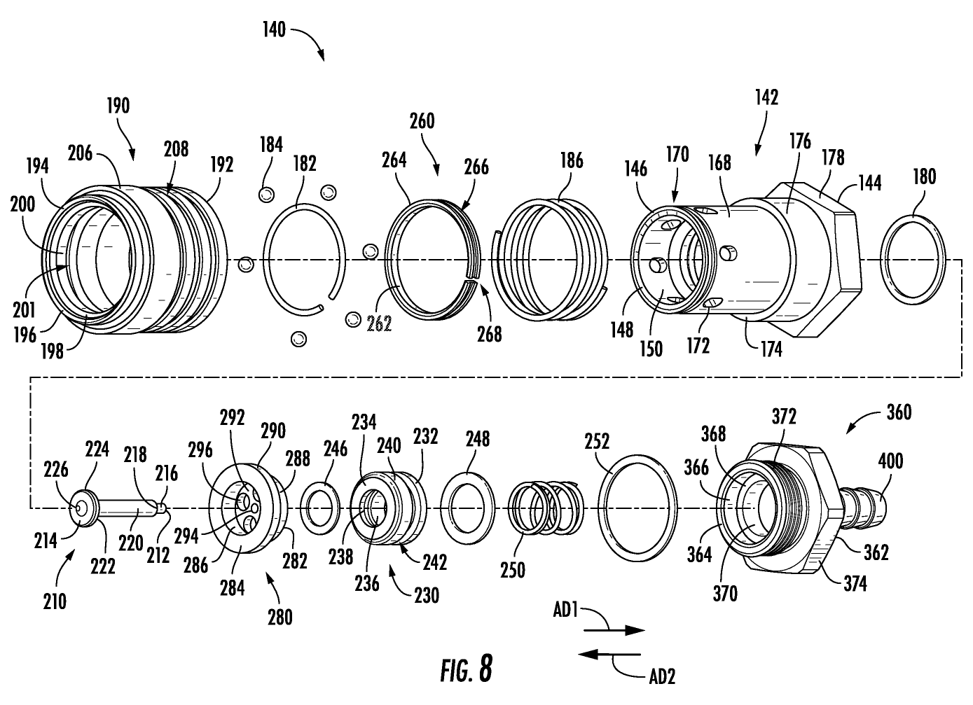

FIG. 6A is a front perspective view of socket assembly 140. FIG. 6B is a top plan view of socket assembly 140, with the sleeve 190 and biasing ring 260 removed. FIG. 7 is a cross-sectional view of socket assembly 140 taken generally along line 7-7 in FIG. 6A. FIG. 8 is an exploded front perspective view of socket assembly 140. FIG. 9 is a cross-sectional view of fluid connection assembly 10 taken generally along line 9-9 in FIG. 1A. Socket assembly 140 generally comprises connector body 142, sleeve 190, biasing element or spring 186, shaft 210, plunger 230, and biasing element or spring 250. In an exemplary embodiment, socket assembly 140 further comprises biasing ring 260. In an exemplary embodiment, socket assembly 140 further comprises securing body 360.

Connector body 142 comprises end 144, end 146, at least one radially inward facing surface, for example, radially inward facing surface 150, radially inward facing surface 154, radially inward facing surface 160, and radially inward facing surface 166, and at least one radially outward facing surface, for example, radially outward facing surface 168 and radially outward facing surface 176. Radially inward facing surface 150 extends from end 146 in axial direction AD1 and is operatively arranged to engage plug assembly 20, namely, radially outward facing surface 50 of connector body 22. In an exemplary embodiment, radially inward facing surface 150 is connected to end 146 via frusto-conical surface 148. Frusto-conical surface 148 increases in diameter in axial direction AD2. Radially inward facing surface 150 is connected to radially inward facing surface 154 via surface 152. In an exemplary embodiment, surface 152 is a frusto-conical surface decreasing in diameter in axial direction AD1. Radially inward facing surface 154 comprises groove 156 within which seal 180 is arranged. Radially inward facing surface 154 is connected to radially inward facing surface 160 via axial surface 158. Axial surface 158 faces generally in axial direction AD1 and extends radially outward from radially inward facing surface 154. Radially inward facing surface 160 is at least partially threaded, including threading 162. In an exemplary embodiment, threading 162 is spaced apart from axial surface 158, thereby forming an unthreaded portion of radially inward facing surface 160 that engages projection 290 of stopper 280. Radially inward facing surface 166 extends from end 144 in axial direction AD2 and is connected to radially inward facing surface 160 via axial surface 164. Axial surface 164 faces generally in axial direction AD1. Radially inward facing surface 166 is operatively arranged to engage seal 252 to create a fluid tight seal between connector body 142 and securing body 360.

Radially outward facing surface 168 extends from end 146 in axial direction AD1 and is connected to radially outward facing surface 176 via axial surface 174. Axial surface 174 extends radially outward from radially outward facing surface 168 and engages spring 186, as will be described in greater detail below. Radially outward facing surface 168 comprises annular groove 170. Locking ring 182 is arranged in groove 170 to prevent sleeve 190 from being removed from connector body 142. In an exemplary embodiment, groove 170 is arranged proximate to, and spaced apart axially from, end 146. In an exemplary embodiment, locking ring 182 is a non-continuous ring having a first circumferential end and a second circumferential end.

Connector body 142 comprises a plurality of circumferentially spaced through-holes or through-slots 172 extending from radially outward facing surface 168 to radially inward facing surface 150. Detents 184 are arranged in respective holes 172 and are arranged to extend radially inward from radially inward facing surface 150 to engage groove 46 of connector body 22 to secure plug assembly 20 to socket assembly 140. Detents 184 are displaceable with respect to holes 172. Sleeve 190 is at least partially aligned with through-holes 172, in connection with biasing ring 260, to force detents 184 radially inward to form the connected state (i.e., plug assembly 20 is connected to socket assembly 140 as shown in FIG. 9). When sleeve 190 is displaced in axial direction AD1 out of alignment with through-holes 172 and detents 184, detents 184 are capable of being displaced radially outward such that plug assembly 20 can be removed from socket assembly 140, as will be described in greater detail below.

As best shown in FIG. 6B, each of through-holes 172 comprises an ovular, elongate slot shape having length L1 (in an axial direction) and width W (generally in a circumferential direction), with length L1 being greater than width W. Detents 184 comprise width or diameter D, which corresponds to width W and is substantially less than length L1. Length L1 of through-holes 172 allow detents 184 to displace axially, for example in axial direction AD1 and axial direction AD2, in through-holes 172 in addition to radially, namely, in radial direction RD1 and radial direction RD2. In particular, detents 184 are operatively arranged to displace in axial direction AD1 within through-holes 172, and once aligned with groove 201 and biasing ring 260, radially outward in radial direction RD1 into groove 201, as will be described in greater detail below.

In an exemplary embodiment, through-holes 172 are frusto-conical such that they decrease in diameter in a radially inward direction, namely, radial direction RD2. For example, each of through-holes 172 has a first width W at radially inward facing surface 150 and a second width W at radially outward facing surface 168 greater than the first width W. The first width W is less than diameter D of detents 184, which prevents detents 184 from falling radially inward through through-holes 172 and into connector body 142.

In an exemplary embodiment, connector body 142 may further comprise head 178 extending from end 144. Connector body 142 may be screwed onto a component, such as securing body 360, via head 178 (e.g., using a wrench). In an exemplary embodiment, head 178 is hexagonal; however, it should be appreciated that head 178 may comprise any geometry suitable for applying torque to connector body 142.

Sleeve 190 is arranged concentrically around connector body 142 and comprises end 192, end 194, at least one radially inward facing surface, for example, radially inward facing surface 196, radially inward facing surface 200, and radially inward facing surface 204, and radially outward facing surface 206. Radially inward facing surface 196 extends from end 194 and is connected to radially inward facing surface 200 via surface 198. In an exemplary embodiment, surface 198 is a frusto-conical surface decreasing in diameter in axial direction AD1. Surface 198 is operatively arranged to engage with locking ring 182 to prevent sleeve 190 from being displaced in axial direction AD2 with respect to connector body 142 (i.e., locking ring 182 prevents removal of sleeve 190 from connector body 142). Radially inward facing surface 200 is connected to radially inward facing surface 204 via axial surface 202. Axial surface 202 faces generally in axial direction AD1 and is operatively arranged to engage spring 186. In an exemplary embodiment, radially outward facing surface 206 comprises a plurality of ridges and/or grooves 208 to help with gripping and displacing sleeve 190.

Radially inward facing surface 200 comprises annular groove 201 extending radially outward therefrom. Groove 201 comprises length L2 (see FIG. 7), which is less than length L1 of through-holes 172. In the engaged state of sleeve 190, as shown in FIGS. 7 and 9, groove 201 is aligned with through-holes 172. Specifically, radially inward facing surface 200 is aligned with a portion of through-holes 172 (i.e., the portion closest to end 146) and groove 201 is aligned with a portion of through-holes 172 (i.e., the portion furthest from end 146).

Biasing ring 260 is arranged in groove 201 and operatively arranged to bias detents 184 radially inward and into engagement with groove 46, as will be described in greater detail below. Biasing ring 260 comprises radially inward facing surface 262, radially outward facing surface 264, and circumferential space 268. Biasing ring 260 is a non-continuous ring or ring-shaped band having a first circumferential end and a second circumferential end, the ends separated by circumferential space 268. Biasing ring 260 is operatively arranged to be elastically radially expanded to allow radial outward displacement of detents 284, and force detents 284 back radially inward. In an exemplary embodiment, radially outward facing surface 264 comprises groove 266. In an exemplary embodiment, groove 266 is arranged axially between and spaced apart from the axial ends of biasing ring 260.

Spring 186 is arranged concentrically around connector body 142 and aligned with radially outward facing surface 168 such that a first end thereof engages axial surface 174 and a second end thereof engages axial surface 202. As such, spring 186 biases sleeve 190 in axial direction AD2 with respect to connector body 142. Specifically, spring 186 biases sleeve 190 into at least partial alignment with through-holes 172, and at least partial engagement with detents 184.

In an exemplary embodiment, socket assembly 140 further comprises stopper 280. Stopper 280 comprises end 282, end 284, radially inward facing surface 286, and radially outward facing surface 288. Radially outward facing surface 288 comprises radially outward extending projection 290 arranged proximate to or at end 284. Projection 290 is operatively arranged to engage axial surface 158 to prevent stopper 280 from being displaced in axial direction AD2 with respect to connector body 142, and end 364 of securing body 360 to prevent stopper 280 from being displaced in axial direction AD1 with respect to connector body 142. Stopper 280 further comprises wall 292 arranged at end 282. Wall 292 comprises through-bore 294 operatively arranged to engage shaft 210. Wall 292 further comprises a plurality of through-holes 296 circumferentially spaced around through-bore 294. Through-holes 296 allow fluid to flow through stopper 280, as indicated by flow path arrows FP3 in FIG. 7. In an exemplary embodiment, stopper 280 is removably connected to connector body 142.

Shaft 210 comprises end 212, end 214, and at least one radially outward facing surface, for example, radially outward facing surface 216, radially outward facing surface 220, and radially outward facing surface 224. Radially outward facing surface 216 extends from end 212 in axial direction AD2 and is connected to radially outward facing surface 220 via axial surface 218. Axial surface 218 faces generally in axial direction AD1 and is operatively arranged to engage wall 292 to prevent shaft from being displaced in axial direction AD1 with respect to connector body 142. Radially outward facing surface 220 is connected to radially outward facing surface 224 via surface 222. In an exemplary embodiment, surface 222 is a frusto-conical surface increasing in diameter in axial direction AD2. Radially outward facing surface 224 extends from end 214 in axial direction AD1 and is operatively arranged to engage radially inward facing surface 236 of plunger 230. In an exemplary embodiment, end 214 further comprises alignment protrusion 226. Protrusion 226 is operatively arranged to engage recess 122 of plunger 100 such that sealing head 117 and/or shaft 210 do not displace radially.

Plunger 230 is arranged in connector body 142 and is slidably displaceable with respect thereto. Plunger 230 comprises end 232, end 234, radially inward facing surface 236, and radially outward facing surface 240. Radially inward facing surface 236 comprises groove 238 in which seal 246 is arranged. Radially outward facing surface 240 comprises groove 242 in which seal 248 is arranged. In an exemplary embodiment, groove 238 is arranged proximate to end 234 and groove 242 is arranged proximate to end 232. As shown in FIG. 7, plunger further comprises recess 244 extending from end 232 in axial direction AD2. Recess 244 is operatively arranged to engage spring 250.

In an exemplary embodiment, the diameter of radially inward facing surface 236 is less than the diameter of radially outward facing surface 224 to prevent plunger 230 from being removed from shaft 210 in axial direction AD2. This allows socket assembly 140 to be pressurized without the need to be connected to socket assembly 140. For example, when socket assembly 140 is pressurized, the fluid pressure will force plunger 230 in axial direction AD2 and into sealing engagement with shaft 210.

Spring 250 is arranged concentrically around shaft 210 and has a first end engaged with wall 292 of stopper 280 and a second end engaged with recess 244 of plunger 230. Spring 250 is operatively arranged to bias plunger 230 in axial direction AD2. Spring 250 biases plunger 230 toward a closed state. In the closed state shown in FIG. 7, radially inward facing surface 236 is engaged with radially outward facing surface 224 and seal 246 is engaged with surface 222, thereby preventing the flow of fluid through plunger 230 in axial direction AD2. In the open state shown in FIG. 9, plunger 230 is displaced in axial direction AD1 with respect to shaft 210, for example by end 24 of connector body 22, such that radially inward facing surface 236 is spaced apart from radially outward facing surface 224. This allows fluid to flow into end 24, as indicated by flow path arrows FP2.

Securing body 360 comprises end 362, end 364, at least one radially inward facing surface, for example, radially inward facing surface 366 and radially inward facing surface 370, and radially outward facing surface 372. Radially inward facing surface 366 extends from end 364 in axial direction AD1 and is arranged to engage radially outward facing surface 288 of stopper 280. Radially inward facing surface 366 is connected to radially inward facing surface 370 via axial surface 368. Axial surface 368 extends radially inward from radially inward facing surface 366 and is operatively arranged to engage end 282 of stopper 280. Stopper 280 is arranged between axial surface 364 and axial surface 158 (i.e., projection 290 of stopper 280 is engaged axially between connector body 142 and securing body 360.

Radially outward facing surface 372 extends from end 364 in axial direction AD1. In an exemplary embodiment, radially outward facing surface 372 is at least partially threaded. In an exemplary embodiment, threading 372 is spaced apart from head 374. In such embodiment, seal 252 is arranged to engage an unthreaded portion of radially outward facing surface 372.

In an exemplary embodiment, securing body 360 may further comprise head 374 arranged at end 362. Securing body 360 may be screwed onto a component, such as connector body 142, via head 374 (e.g., using a wrench). In an exemplary embodiment, head 374 is hexagonal; however, it should be appreciated that head 374 may comprise any geometry suitable for applying torque to securing body 360.

Securing body 360 is operatively arranged to be fluidly connected to a tube or other component. In an exemplary embodiment, socket assembly 140 further comprises fitting 400. Fitting 400 is operatively arranged to connect securing body 360 to a tube or other component for example, via brazing, a pipe clamp, quick connect, retaining ring, or another suitable securing means. Fitting 400 comprises a radially outward facing surface having a plurality of grooves or ridges. In an exemplary embodiment, fitting or spigot 400 and securing body 360 are integrally formed.

To assemble socket assembly 140, spring 186 is arranged around connector body 142 and aligned with radially outward facing surface 168. Detents 184 are arranged in through-holes 172. Biasing ring 260 is arranged in groove 201 of sleeve 190. Sleeve 190 is arranged on connector body 142 and aligned with radially outward facing surface 168 such that spring 186 is engaged with axial surface 174 and axial surface 202. Locking ring 182 is then arranged in groove 170, thereby securing sleeve 190 to connector body 142. Seal 180 is arranged in groove 156.

Seal 246 is arranged in groove 238 and seal 248 is arranged in groove 242. Plunger 230 is arranged around shaft 210, spring 250 is arranged around shaft 210 and engaged with recess 244 of plunger 230, and shaft 210 is engaged with through-bore 294 of stopper 280 such that wall 292 engages spring 250. Shaft 210, plunger 230, spring 250, and stopper 280 are inserted into connector body 142 such that radially outward facing surface 240 of plunger 230 is engaged with radially inward facing surface 154 and projection 290 is engaged with axial surface 158 and radially inward facing surface 160. Seal 252 is arranged on securing body 360, and securing body 360 is connected to connector body 142, for example via threading 162 and threading 372.

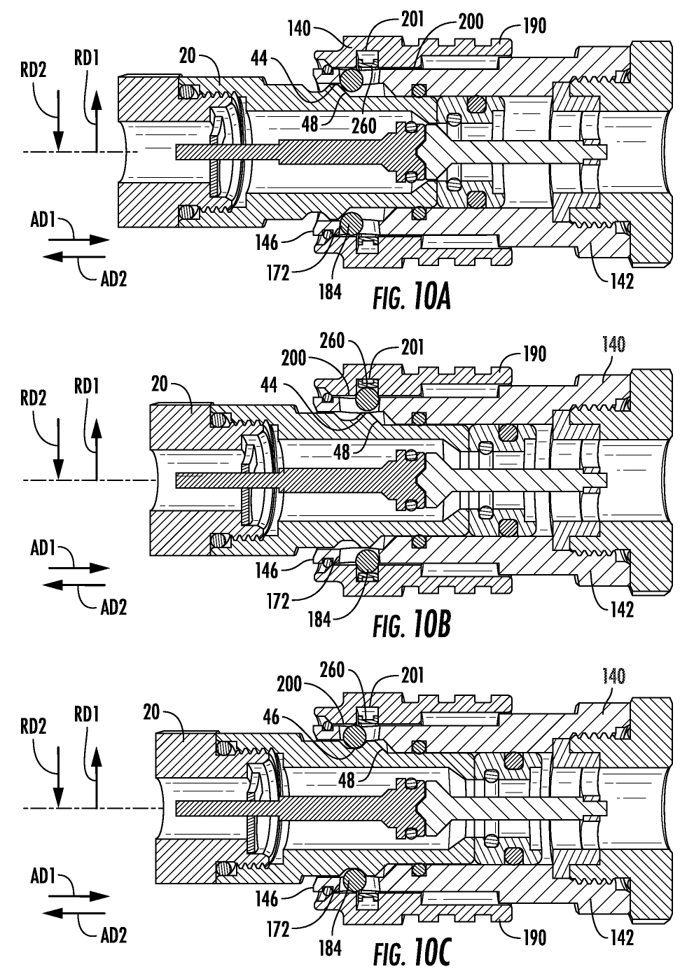

FIGS. 10A-10C illustrate the push-to-connect feature of fluid connection assembly 10. FIG. 10A is a cross-sectional view of fluid connection assembly 10 taken generally along line 9-9 in FIG. 1A, in an unlocked state. As shown, plug assembly 20 is partially engaged with socket assembly 140 such that surface 48 of plug assembly 20 is not engaged with detents 184. In the unlocked state, detents 184 may be axially aligned with radially inward facing surface 200, groove 201, or both. For example, detents 184 may be arranged in through-holes 172 closest to end 146, furthest from end 146, or axially therebetween. However, in the unlocked state, detents 184 are always arranged radially inward of radially inward facing surface 200.

FIG. 10B is a cross-sectional view of fluid connection assembly 10 taken generally along line 9-9 in FIG. 1A, in a partially engaged state. As shown, in the partially engaged state surface 48 and/or surface 44 is engaged with detents 184 such that detents 184 are forced radially outward. As plug assembly 20 is displaced in axial direction AD1 with respect to socket assembly 140, surface 48 displaces detents 184 in axial direction AD1 until they align axially with groove 201. The frusto-conical nature of surface 48 in connection with through-holes 172 force detents 184 radially outward in radial direction RD1. The radially inward force of biasing ring 260 is overcome thus allowing detents 184 to enter groove 201 providing clearance for radially outward facing surface 44. Biasing ring 260 expands radially outward deeper into groove 201.

FIG. 10C is a cross-sectional view of fluid connection assembly 10 taken generally along line 9-9 in FIG. 1A, in a locked state. Once groove 46 is aligned with groove 201, biasing ring 260 forces detents 184 back radially inward and into groove 46. The engagement of detents 184 with groove 46 and through-holes 172 thus prevents plug assembly 20 from being removed from (i.e., displaced in axial direction AD2 with respect to) socket assembly 140. This single push-to-connect fluid connection assembly 10 is advantageous as it allows the assembler to connect plug assembly 20 and socket assembly 140 in one singular, quick, linear movement, for example without the need to displace a locking sleeve or secure a retaining ring, while maintaining a pressurized fluid tight seal in both plug assembly 20 and socket assembly 140.

To disconnect, sleeve 190 is displaced in axial direction AD1 with respect to connector body 142 to allow detents 184 the ability to displace radially outward with respect to radially inward facing surface 200. Plug assembly 20 can then be removed from socket assembly 140 in axial direction AD2.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fluid connection assembly

20 Plug assembly

22 Connector body

24 End

26 End

28 Radially inward facing surface

30 Axial surface

32 Radially inward facing surface

34 Surface

36 Radially inward facing surface

37 Radially inward facing surface

38 Groove or recess

40 Surface

42 Head

44 Radially outward facing surface

46 Groove

48 Surface

50 Radially outward facing surface

60 Securing body

62 End

64 End

66 Radially inward facing surface

68 Radially outward facing surface

70 Head

72 Radially outward facing surface

74 Threading

76 Radially outward facing surface

78 Surface

80 Stopper

82 End

84 End

86 Through-bore

88A Projection

88B Projection

88C Projection

90 Ring assembly

92 Outer ring

94 Seal

96 Flange

98 Seal

100 Plunger

102 End

104 End

106 Radially outward facing surface

108 Axial surface

110 Radially outward facing surface

112 Surface

114 Radially outward facing surface

115 Axial surface

116 Radially outward facing surface

117 Sealing head

118 Radially outward facing surface

120 Groove

122 Recess

124 Seal

130 Spring

132 End

134 End

140 Socket assembly

142 Connector body

144 End

146 End

148 Surface

150 Radially inward facing surface

152 Surface

154 Radially inward facing surface

156 Groove

158 Axial surface

160 Radially inward facing surface

162 Threading

164 Axial surface

166 Radially inward facing surface

168 Radially outward facing surface

170 Groove

172 Through-holes

174 Axial surface

176 Radially outward facing surface

178 Head

180 Seal

182 Locking ring

184 Detents or balls

186 Spring

190 Sleeve

192 End

194 End

196 Radially inward facing surface

198 Surface

200 Radially inward facing surface

201 Groove

202 Axial surface

204 Radially inward facing surface

206 Radially outward facing surface

208 Grooves

210 Shaft

212 End

214 End

216 Radially outward facing surface

218 Axial surface

220 Radially outward facing surface

222 Surface

224 Radially outward facing surface

226 Protrusion

230 Plunger

232 End

234 End

236 Radially inward facing surface

238 Groove

240 Radially outward facing surface

242 Groove

244 Recess

246 Seal

248 Seal

250 Spring

252 Seal

254 Seal

260 Biasing ring

262 Radially inward facing surface

264 Radially outward facing surface

266 Groove

268 Circumferential space

280 Stopper

282 End

284 End

286 Radially inward facing surface

288 Radially outward facing surface

290 Projection

292 Wall

294 Through-bore

296 Through-holes

360 Securing body

362 End

364 End

366 Radially inward facing surface

368 Axial surface

370 Radially inward facing surface

372 Radially outward facing surface

374 Head

400 Fitting

AD1 Axial direction

AD2 Axial direction

CD1 Circumferential direction

CD2 Circumferential direction

D Diameter

FP1 Flow path

FP2 Flow path

FP3 Flow path

L1 Length

L2 Length

RD1 Radial direction

RD2 Radial direction

W Width

What is claimed is:

1. A fluid connection assembly, comprising:
a plug assembly, including:
a first end;
a second end;
a first radially outward facing surface including a first groove;
a first through-bore forming a first radially inward facing surface;
a first plunger arranged in the first through-bore; and
a first spring operatively arranged to bias the first plunger into sealing engagement with the first end; and
a socket assembly, including:
a third end;
a fourth end;
a second radially outward facing surface;
a second through-bore forming a second radially inward facing surface;
one or more holes extending from the second radially outward facing surface to the second radially inward facing surface;
a detent arranged in each hole of the one or more holes;
a biasing ring arranged radially outward of the second radially outward facing surface, the biasing ring operatively arranged to engage the detent;
a second plunger arranged in the second through-bore; and
a second spring operatively arranged to bias the second plunger into a sealed state.

2. The fluid connection assembly as recited in claim 1, wherein the biasing ring is a non-continuous radially expandable ring operatively arranged to bias the detent radially inward.

3. The fluid connection assembly as recited in claim 1, wherein the socket assembly further comprises a sleeve translatably arranged on the second radially outward facing surface.

4. The fluid connection assembly as recited in claim 3, wherein:
the detent is radially and axially displaceable within the one or more holes; and
the sleeve and the biasing ring are operatively arranged to engage the detent to displace it radially inward from the second radially inward facing surface.

5. The fluid connection assembly as recited in claim 3, wherein the sleeve comprises:
a third radially inward facing surface; and
a second groove arranged on the third radially inward facing surface, wherein the biasing ring is arranged in the second groove and the second groove is operatively arranged to be axially aligned with the one or more holes.

6. The fluid connection assembly as recited in claim 5, wherein:
each hole of the one or more holes comprises a first axial length;
the second groove comprises a second axial length; and
the second axial length is less than the first axial length.

7. The fluid connection assembly as recited in claim 5, wherein the detent is operatively arranged to be displaced radially outward into the second groove by the plug assembly.

8. The fluid connection assembly as recited in claim 1, further comprising a third spring operatively arranged to bias the biasing ring into axial alignment with the one or more holes.

9. The fluid connection assembly as recited in claim 1, wherein:
the socket assembly further comprises a shaft arranged in the second through-bore; and
the second spring is operatively arranged to bias the second plunger into sealing engagement with the shaft.

10. The fluid connection assembly as recited in claim 9, wherein the second plunger comprises:
a third radially outward facing surface including a second groove;
a first seal arranged in the second groove to provide a fluid tight seal between the second plunger and the second radially inward facing surface;
a third radially inward facing surface including a third groove; and
a second seal arranged in the third groove to provide a fluid tight seal between the second plunger and the shaft.

11. The fluid connection assembly as recited in claim 1, wherein in an unconnected state:
the first plunger is sealingly engaged with the first end; and
the second plunger is in the sealed state and sealingly engaged with the second radially inward facing surface.

12. The fluid connection assembly as recited in claim 11, wherein in a connected state:
the first end displaces the second plunger in a first axial direction such that the second plunger is in an unsealed state; and
the first plunger is displaced in a second axial direction, opposite the first axial direction, such that the first plunger is not sealingly engaged with the first end.

13. The fluid connection assembly as recited in claim 12, wherein in the connected state the second plunger is sealingly engaged with the second radially inward facing surface.

14. The fluid connection assembly as recited in claim 1, wherein the detent is operatively arranged to engage the first groove and the one or more holes to lock the plug assembly to the socket assembly.

15. A fluid connection assembly, comprising:
a plug assembly, including:
a first end;
a second end;
a first radially outward facing surface including a first groove; and
a first through-bore forming a first radially inward facing surface;
a socket assembly, including:
a third end;
a fourth end;
a second radially outward facing surface;
a second through-bore forming a second radially inward facing surface;
one or more holes extending from the second radially outward facing surface to the second radially inward facing surface;
a detent arranged in each hole of the one or more holes; and
a biasing ring operatively arranged to engage the detents.

16. The fluid connection assembly as recited in claim 15, wherein the biasing ring is a radially expandable ring operatively arranged to bias the detent radially inward.

17. The fluid connection assembly as recited in claim 15, wherein:
the socket assembly further comprises a sleeve arranged on the second radially outward facing surface;
the sleeve comprises a third radially inward facing surface including a second groove; and
the biasing ring is arranged in the second groove and operatively arranged to be axially aligned with the one or more holes.

18. The fluid connection assembly as recited in claim 17, wherein:
each hole of the one or more holes comprises a first axial length;
the second groove comprises a second axial length; and
the second axial length is less than the first axial length.

19. The fluid connection assembly as recited in claim 17, wherein the detent is operatively arranged to:
be displaced radially outward into the second groove by the plug assembly; and
engage the first groove and the one or more holes to lock the plug assembly to the socket assembly.

20. The fluid connection assembly as recited in claim 15, wherein:
the detent is radially and axially displaceable within the one or more holes; and
the biasing ring is translatably arranged on the second radially outward facing surface.
